(19) United States
(12) Patent Application Publication
(10) Pub. No.: US 2026/0288160 A1
(43) Pub. Date: Sep. 24, 2026

(54) AUTONOMOUS WORK VEHICLE INCLUDING FOLLOW ME FUNCTION

(71) Applicant: Honda Motor Co., Ltd., Tokyo (JP)

(72) Inventors: Maruthi GOVINDARAJAN, Hillsborough, NC (US); Dylan FENDRICH, Jamestown, NC (US); Joshua COOLEY, Whitsett, NC (US)

(21) Appl. No.: 19/084,717

(22) Filed: Mar. 19, 2025

(51) Int. Cl. G05D 1/65; G05D 1/678; G05D 109/10; G05D 111/10; G05D 111/30; G05D 111/50

(52) U.S. Cl. CPC G05D 1/65; G05D 1/678; G05D 2109/10; G05D 2111/17; G05D 2111/30; G05D 2111/54

(57) ABSTRACT

An autonomous work vehicle can include a plurality of wheels with at least one steerable wheel. An electric drive motor can be connected to at least one of the wheels, and an electric steering motor can be connected to the steerable wheel to cause the at least one steerable wheel to pivot. An imaging device can be mounted on the vehicle body and configured to output image data indicative of an external environment through which the vehicle is travelling. A tether can be connected to the vehicle body and to a guide, such as a person or another vehicle. A controller can be in electrical communication with the electric drive motor, the electric steering motor, the imaging device, and direction and range sensors associated with the tether, in order to power and steer the vehicle over a new or predefined path.

### BACKGROUND

The disclosed subject matter relates to an autonomous vehicle. More particularly, the disclosed subject matter relates to an off-road autonomous work vehicle that includes a follow me function.

An autonomous vehicle can transport one or more passengers and/or cargo from a starting point to a destination. Some autonomous vehicles can be programmed to follow a predetermined travel path from the starting point to the destination. The autonomous vehicle can include one or more sensors to detect the predetermined path and/or obstacles that are on, near, enter, or exit the predetermined travel path. Other autonomous vehicles can use a plurality of sensors, map data, and a global position system (GPS) to create a travel path from the starting point to the destination.

The autonomous vehicle can include a plurality of drive sensors/systems such as, but not limited to a camera, GPS, satellite communications, a lidar device and a radar device. For example, the autonomous vehicle can include at least one camera, a plurality of lidar devices, and a plurality of radar devices. Each sensor can scan a respective field of view of the environment through which the vehicle is traveling. The vehicle can include a controller that is configured to detect the travel path with one or more of the sensors and determine whether an obstacle is in, near, entering, or exiting the travel path. The controller can be configured to modify the previously created travel path if an obstacle is present in the travel path or will enter or exit the travel path at a location that intersections a future location of the vehicle along the travel path. As a result, the vehicle can avoid the obstacle and continue toward the destination.

### SUMMARY

Some embodiments are directed to an autonomous work vehicle that can include: a vehicle body; a plurality of wheels mounted on the vehicle body, each of the wheels is rotatable about a respective rotational axis, the plurality of wheels includes at least one steerable wheel that pivots about a respective steering axis that is different from the respective rotational axis; an electric drive motor connected to at least one of the wheels and configured to output a drive torque to the at least one of the wheels; an electric steering motor connected to the steerable wheel and configured to cause the at least one steerable wheel to pivot about the respective steering axis; an imaging device mounted on the vehicle body and configured to output image data indicative of an external environment through which the vehicle is travelling; a tether connected to the vehicle body and selectively extending towards and away from the vehicle body and is pivotable relative to the vehicle body, the tether includes a free end that is configured to be connected to a guide; a directional sensor configured to output directional data indicative of the direction of travel of the guide relative to the vehicle based on a location associated with the free end of the tether relative to the vehicle body; a distance sensor configured to output range data indicative of a distance from the vehicle to the guide based on the location associated with the free end of the tether relative to the vehicle body; and, a controller in electrical communication with the electric drive motor, the electric steering motor, the imaging device, the direction sensor, and the range sensor, the controller configured to: convert the directional data into a steering angle and cause the electric steering motor to pivot the steering wheel based on the steering angle and the image data; and convert the range data into a vehicle speed and cause the electric drive motor to drive the at least one of the wheels based on the vehicle speed and the image data.

In accordance with another embodiment, an autonomous work vehicle, can include: a plurality of wheels, each of the wheels is rotatable about a respective rotational axis, the plurality of wheels includes at least one steerable wheel that pivots about a steering axis that is different from the respective rotational axis; power source connected to at least one of the wheels and configured to output a drive torque to the at least one of the wheels; a steering motor connected to the steerable wheel and configured to cause the steerable wheel to pivot about the steering axis; an imaging device configured to output image data indicative of an external environment through which the vehicle is travelling; a tether sensor assembly including: a housing; a tether that is connected to the housing, the tether configured to selectively extend out of and retract into the housing and is pivotable relative to the housing about a pivot axis, the tether includes a free end that is configured to be connected to a guide; and a direction sensor configured to output directional data indicative of the direction of travel of the guide relative to the vehicle based on an angle at which the tether extends away from the housing; and a distance sensor configured to output range data indicative of the distance from the vehicle to the guide based on an amount of the tether that is pulled out of the housing; and a controller in electrical communication with the power source, the steering motor, the imaging device, and the tether sensor assembly, the controller configured to: convert the directional data into a steering angle and cause the steering motor to pivot the steering wheel based on the steering angle and the image data; and convert the range data into a vehicle speed and cause the power source to drive the at least one of the wheels based on the vehicle speed and the image data.

In accordance with another embodiment, an autonomous work vehicle, can include: a pair of front wheels, each of the front wheels is rotatable about a respective rotational axis and pivotable about a respective steering axis that is different from the rotational axis; a pair of rear wheels, each of the rear wheels is rotatable about a common rotational axis; a power source connected to and configured to output a drive torque to the rear wheels; an electric steering motor connected to the front wheels and configured to cause each of the front wheels to pivot about the respective steering axis; an imaging device configured to output image data indicative of an external environment through which the vehicle is travelling; a tether sensor assembly including: a housing; a tether that is connected to the housing and selectively extends out of and retracts into the housing and is pivotable relative to the housing about a pivot axis, the tether includes a free end that is configured to be connected to a guide; and a direction sensor configured to output directional data indicative of the direction of travel of the guide relative to the vehicle based on an angle at which the tether extends away from the housing; and a distance sensor configured to output range data indicative of the distance from the vehicle to the guide based on an amount of the tether that is pulled out of the housing; and a controller in electrical communication with the power source, the electric steering motor, the imaging device, and the tether sensor assembly, the controller configured to: convert the directional data into a steering angle and cause the electric steering motor to pivot the front wheels based on the steering angle and the image data; and convert the range data into a vehicle speed and cause the electric drive motor to drive the rear wheels based on the vehicle speed and the image data.

### BRIEF DESCRIPTION OF THE DRAWINGS

The disclosed subject matter of the present application will now be described in more detail with reference to exemplary embodiments of the apparatus and method, given by way of example, and with reference to the accompanying drawings, in which:

FIG. 1 is a side view of an off-road autonomous work vehicle and a guide tethered to the autonomous vehicle all made in accordance with principles of the disclosed subject matter.

FIG. 2 is a side view of the vehicle of FIG. 1 with side gates in a lowered position and tail gate in a raised position.

FIG. 3 is a schematic view of the vehicle of FIG. 1.

### DETAILED DESCRIPTION OF EXEMPLARY EMBODIMENTS

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows.

An autonomous vehicle that includes a controller analyzes image data received from various sources, such as a camera, a lidar device and a radar device, in order to detect and avoid obstacles and confirm that the vehicle is following a travel path that will lead to the destination. However, an autonomous driving system that relies on this image data can be expensive, complex, and unreliable under certain environmental conditions.

Instead of the autonomous vehicle creating its own path of travel, a user of the autonomous vehicle can program the travel path into the vehicle's controller or electronic storage device. However, it can take time to create a map of the travel path and upload it into the vehicle's controller.

Sometimes it can be advantageous to use the same autonomous vehicle at different starting points and/or different destinations. Thus, the vehicle memory size increases and the time to prepare and upload the plurality of maps increases. Further, the user might not know ahead of time that the route for the travel path is a new route and might not have sufficient time to prepare and upload the program for the new route. Thus, the versatility of the autonomous vehicle can be decreased as compared to a manned vehicle.

It can be advantageous for a user to drive the autonomous vehicle using a remote control if a map of the new route cannot be uploaded before using the autonomous vehicle. Specialized training and/or skill set for the user might be advantageous for operating the autonomous vehicle. Thus, the training and skill of the user can increase the cost of operating the autonomous vehicle.

In view of these potential disadvantages and drawbacks, it can be advantageous to provide an autonomous vehicle with the ability to drive in a fully autonomous or a follow me mode so that the user can use (and/or train) the vehicle on predetermined routes as well as under dynamic or ad hoc scenarios. The follow me mode can permit the vehicle to follow a designated guide along the new travel path. As a result, a pre-existing map is not required, and it is not necessary for the user to create a map before departure along the new travel path. Thus, the autonomous vehicle can be instantly usable without any complex preparatory steps.

Further, the autonomous vehicle can learn the new travel path while operating in the follow me mode. Thus, the autonomous vehicle can repeat the new travel path in the fully autonomous mode without the user preparing and uploading a route map ahead of time.

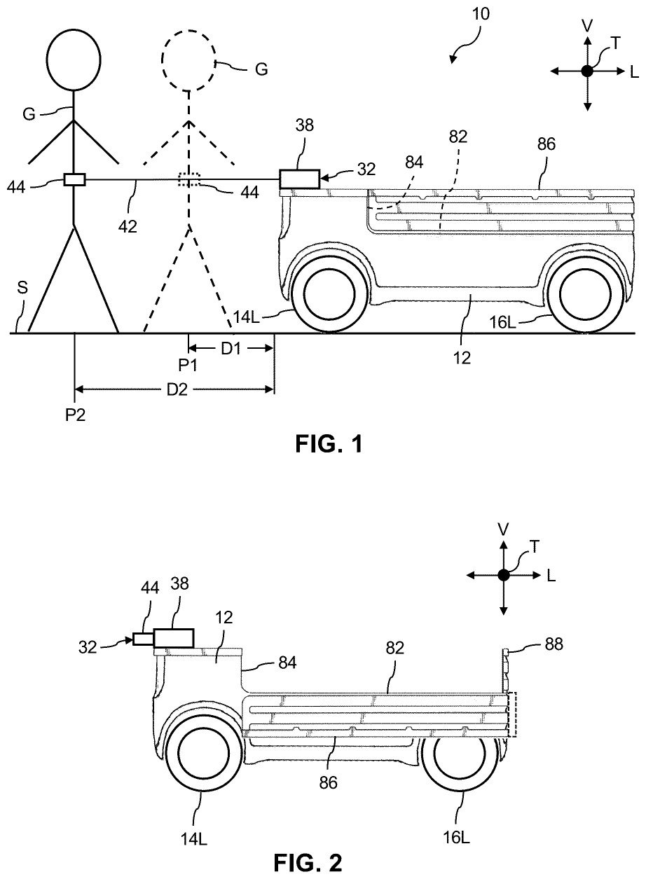

FIGS. 1 and 2 illustrate an embodiment of an off-road, autonomous work vehicle (“vehicle”) 10 made in accordance with principles of the disclosed subject matter. The vehicle 10 can be configured to travel along an improved path (such as paths paved with a durable surface material, e.g., asphalt, concrete, stone, brick, etc.), an unimproved path (such as a dirt path), and/or any unmarked path of travel (such as along a wooded area, open field, rocky area, sand, water feature, etc.). The vehicle 10 can be specially configured to enhance performance while traveling along an unimproved or unmarked path of travel. This specialized configuration can include increased suspension travel, increased ground clearance, and/or enhanced durability, as compared to vehicles configured for travel along an improved path.

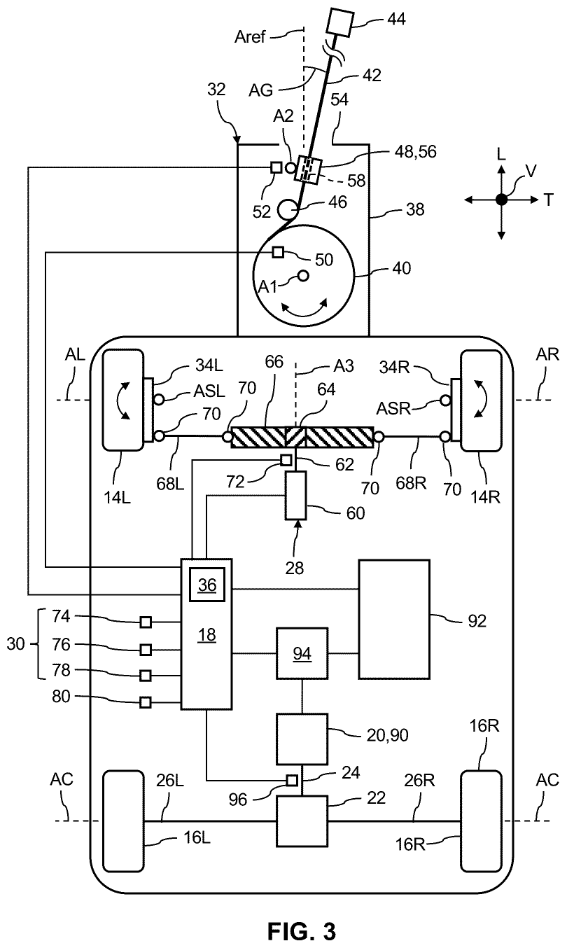

Referring to FIGS. 1-3, the vehicle 10 can extend in a longitudinal direction L, a transverse direction T and a vertical direction V. Referring to FIG. 3, the vehicle 10 can include a body 12, a pair of front wheels 14L, 14R, a pair of rear wheels 16L, 16R, a controller 18, a power source 20, a differential gear assembly 22, a propeller shaft 24, a pair of driveshafts 26L, 26R, a steering mechanism 28, an imaging device 30 and a tether sensor assembly 32. The right wheels 14R, 16R are obstructed from view in FIGS. 1 and 2.

Referring to FIGS. 1-3, the wheels 14L, 14R, 16L, 16R can support the body 12 above a travel surface S (FIG. 1). Each of the wheels 14L, 14R, 16L, 16R can be connected to the body 12 so that the front wheels 14L, 14R, can rotate about respective rotational axes AL, AR. The rear wheels 16L, 16R can be connected to the body 12 so that the rear wheels 16L, 16R, can rotate about a respective rotational axis AC that is common to both rear wheels 16L, 16R.

Referring to FIG. 3, the vehicle 10 can include a pair of steering knuckles 34L, 34R, one for each of the front wheels 14L, 14R. Each of the steering knuckles 34L, 34R can be connected to the body 12 such that each of the steering knuckles 34L, 34R rotates about a respective steering axis ASL, ASR. Each of the front wheels 14L, 14R can be connected to the respective one of the steering knuckles 34L, 34R so that the wheels 14L, 14R rotate relative to the respective one of the steering knuckles 34L, 34R about the respective rotational axis AL, AR.

The controller 18 can be configured to drive the vehicle 10 according to uploaded map(s) in an auto mode, and according to data from the tether sensor assembly 32 in a follow me mode. In the auto mode, the controller 18 can be configured to drive and steer the vehicle 10 according to a predetermined route that is uploaded in a memory storage device 36. In the follow me mode, the tether sensor assembly 32 can be connected to a guide G such as, but not limited to, a person or another vehicle. The guide G can walk/drive along a desired path and the controller 18 can be configured to drive the vehicle 10 along the desired path set by the guide G.

The tether sensor assembly 32 can be configured to output data that is indicative of the relative distance from the vehicle 10 to the guide G and the relative direction (also referred to as a heading or a bearing) of the guide G relative to the vehicle 10. The controller 18 can be configured to convert the distance and directional data into a vehicle speed (also referred to as a velocity) and a steering angle. The controller 18 can be configured to cause the power source 20 to output a drive torque that corresponds to the velocity and cause the steering mechanism 28 to steer the front wheels 14L, 14R in a direction that corresponds to the steering angle. The controller 18 can be configured to increase/decrease the vehicle speed, and stop or start travel of the vehicle 10 based on the distance between the vehicle 10 and the guide G.

The controller 18 can be referred to as an electronic control unit (ECU), a central processing unit (CPU), a microprocessor or a microcomputer. The controller 18 can be configured with hardware, with or without software, to perform the assigned task(s). The controller 18 can include a memory device 36 such as, but not limited to, a ROM, an EEPROM, and/or a RAM. The memory device 36 can be configured to store software and/or data received from the image device 30 and data created by the controller 18.

The tether sensor assembly 32 can include a housing 38, a spool 40, a tether 42, an anchor 44, a fixed guide 46, a pivoting guide 48, a distance sensor 50 and a direction sensor 52.

The housing 38 can contain the spool 40, the fixed guide 46, the pivoting guide 48 and the sensors 50, 52. The housing 38 can include an opening 54 through which the tether 42 extends and retracts.

The spool 40 can be supported in the housing 38 to rotate about a first rotational axis A1. A first end of the tether 42 can be fixed to the spool 40 and the tether 42 can be wound onto and unwound from the spool 40 as the tether 42 retracts into and extends from the housing 38, respectively. The spool 40 can be biased by a spring in a direction that causes the spool to retract the tether 42 into the housing 38 and applies a predetermined tension on the portion of the tether 42 that extends outside of the housing 38.

The tether 42 can be any appropriate structure that can be readily wound onto and unwound from the spool 38, and that exhibits a negligible amount of sag under the predetermined tension when a portion of tether 42 extends out of the housing 38. A negligible amount of sag can correspond to a distance measured by the distance sensor 50 that is within a desired accuracy to a straight line distance from the vehicle 10 to the guide G. For example, the tether 42 can be a metal wire or a plastic string. FIG. 1 shows the tether 42 in the fully extended state and the guide at a maximum position P2 in solid lines and shows the guide G in an intermediate position P1 in phantom. FIG. 2 shows the tether 42 in the fully retracted state.

A second end of the tether 42 can be fixed to the anchor 44. The anchor 44 can be configured to removably secure the tether 42 to the guide G. The anchor 44 can be any appropriate structure such as, but not limited to a clip, a clasp, a magnet, a screw, a bolt, or a clamp.

The fixed guide 46 can be connected to and extend from an inside surface of the housing 38. The fixed guide 46 can be any appropriate structure such as, but not limited to, a hollow cylindrical post, a solid cylindrical post, a pin, a flat wall, or a curved wall. The guide wall 46 can be configured to guide the tether 42 toward the pivoting guide 48 as the tether unwinds from the spool 40.

The pivoting guide 48 can include a main body 56 and a guiding structure 58 such as, but not limited to, an eyelet extending from the main body 56 or a through hole through the main body 56. The pivoting guide 48 can be supported in the housing 38 to pivot about a second axis A2.

The distance sensor 50 can be any appropriate sensor such as, but not limited to, a potentiometer that can output range data that is indicative of the length of the portion of the tether 42 that is extracted out of the housing 38. The length of the extracted portion of the tether 42 can be indicative of the distance from the vehicle 10 to the guide G. Referring to FIG. 1, the range data can indicate a length that corresponds to a first distance D1 if the guide is at a first range P1 relative to the vehicle 10 and a second distance D2 if the guide is at a second range P2 relative to the vehicle 10.

The direction sensor 52 can be any appropriate sensor such as, but not limited to, an encoder that can output data that is indicative of the angle AG between a reference axis Aref and the portion of the tether 42 that is extracted from the housing 38. The encoder can include a toothed wheel that pivots as the main body 56 pivots and a detector that emits an electrical pulse as each tooth passes by the detector. The reference axis Aref can be parallel to the longitudinal direction L of the vehicle 10 and can correspond to a straight line travel path of the vehicle 10.

The power source 20 can be configured to output a drive torque to propel the vehicle 10 at the vehicle speed. The controller 18 can be configured to cause the power source 20 to increase the drive torque if the distance between the vehicle 10 and the guide is increasing, decrease the drive torque if the distance between the vehicle 10 and the guide G is decreasing, or maintain the instant drive torque if the instant distance between the vehicle 10 and the guide is unchanged from the previous distance. The controller 18 can be configured to cause the power source to terminate the drive torque, or maintain the drive torque at zero, if the distance between the vehicle 10 and the guide is less than or equal to a predetermined distance. The controller 18 can be configured to cause the power source to start the drive torque, or continue outputting the drive torque if the distance between the vehicle 10 and the guide is greater than the predetermined distance. The predetermined distance can be set at any appropriate value that can achieve the desired performance of the follow me mode and the comfort level desired by the guide G, especially if the guide G is a person.

The steering mechanism 28 can include a steering motor 60, an output shaft 62, a pinion gear 64, a rack gear 66, and a pair of tie rods 68L, 68R.

Steering motor 60 can be in electrical communication and controlled by the controller 18. The steering motor 60 can be any electric motor such as, but not limited to, a DC electric motor, or a reversible AC electric motor.

The output shaft 62 can be part of or separate from and connected to the steering motor 60. The output shaft 62 can be connected to the pinion gear 64 in any appropriate manner such as, but not limited to, spline teeth.

The pinion gear 64 can include gear teeth and the rack gear 66 can include gear teeth that mesh with the with the gear teeth of the pinion gear 64. The steering motor 60 can rotate the pinion gear 64 and the output shaft 62 about a third rotational axis A3. The third rotational axis can have appropriate orientation with respect to the directions L, T, V of the vehicle 10 so that rotation of the pinion gear 64 can cause the rack gear 66 to move along the transverse direction T of the vehicle 10.

The left tie rod 68L can be connected to the left knuckle 34L and the rack gear 66 and the right tie rod 68R can be connected to the right knuckle 34R and the rack gear 66 in any appropriate manner. For example, a pair of ball joints 70 can connect each of the tie rods 68L, 68R to the rack gear 66 and a respective one of the knuckles 34L, 34R.

The controller 18 can be configured to cause the steering motor 60 to rotate the pinion gear based on the directional data output by the direction sensor 52. The controller 18 can be configured to convert the directional data into a steering angle that represents a rotational angle through which the output shaft 62 is rotated.

The steering mechanism 28 can include a rotation sensor 72 that is configured to measure the rotational motion of the output shaft 62 and output data indicative of the angular rotation of the output shaft 62 to the controller 18. The controller 18 can be configured to drive the steering motor 60 until the angular rotation of the output shaft is equal to the steering angle. The rotation sensor 72 can be an absolute position sensor or a relative position sensor.

The image device 30 can include at least one of a radar 74, a lidar 76 and a camera 78. The controller 18 can be in electrical communication with the image device. The radar 74 can be configured to emit and receive radio waves and detect the presence of one or more objects in and along the path of the vehicle 10 and determine the distance from the vehicle 10 to the object(s). The lidar 76 can be configured to emit and receive a laser light and detect the presence of one or more objects in and along the path of the vehicle 10 and determine the distance from the vehicle 10 to the object(s). The camera 78 can be configured to capture video data of the travel path and the adjacent environment as the vehicle 10 travels along the travel path. The controller 18 can be configured to receive the data/signals from the image device 30, which can be used in combination with predetermined map route information stored in the memory storage device 30 to drive and steer the vehicle 10 in order to steer around any obstacle that may oppose or obstruct the travel path of the vehicle 10 and subsequently return to the predetermined map route.

The vehicle 10 can include a GPS antenna 80 that is configured to send and receive location data from a GPS system that is external to the vehicle 10. The controller 18 can be configured to use the GPS location data to determine an avoidance and return path that the vehicle 10 can follow to steer around any object(s) that are on or near the travel path. The controller 18 can be configured to use the GPS location data to confirm that the vehicle 10 is correctly following the directions set by the predetermined map route.

In the follow me mode, the controller 18 can be configured to receive data/signals from the image device 30 and/or the GPS antenna 80. This can greatly increase the certainty of tracking and following the designated guide G and enhance safety redundancy in combination with the data/signals that the controller receives from the tether sensor assembly 32.

Accordingly, the controller 18 can be configured to drive and steer the vehicle 10 in an autonomous mode and a follow me mode so that the user can use the vehicle 10 on predetermined routes as well as under dynamic or ad hoc scenarios. The follow me mode can permit the vehicle 10 to follow a designated guide G along the new travel path. As a result, a pre-existing map is not required, and it is not necessary for the user to create a map before departure along the new travel path. Thus, the vehicle 10 can be instantly usable without any complex preparatory steps.

Further, the vehicle 10 can learn the new travel path while operating in the follow me mode. Thus, the vehicle 10 can repeat the new travel path in the fully autonomous mode without the user preparing and uploading a route map ahead of time.

Returning to FIGS. 1 and 2, the vehicle 10 can be configured to transport cargo from a start point to a destination, and the body 12 can include a cargo bed 82 and a front wall 84 that extends along a front end of the cargo bed, The vehicle 10 can include a pair of side gates 86 and a tail gate 88 that extend along the sides and the rear end of the cargo bed 82, respectively. The right side gate is obstructed from view by the left side gate 86 in FIG. 1 and by the body 12 in FIG. 2, and the tail gate 88 is obstructed from view by the left side gate 86 in FIG. 1. The gates 86, 88 are in the raised position in FIG. 1 and the side gates 86 are in the lowered position in FIG. 2. FIG. 2 shows the tail gate 88 in the raised position in solid lines and in the lowered position in phantom lines.

The gates 86, 88 can be connected to the body 12 by any appropriate manner that permits the gates 86, 88 to move from the raised position to the lowered position, such as, but not limited to, a hinge(s), slide rail(s), a slide pocket that extends into the body 12.

The vehicle 10 can be configured as a battery electric vehicle and the power source 20 can include an AC electric motor 90. Vehicle 10 can include a battery 92 and an inverter 94 (also referred to as a motor driver) in electrical communication with the battery 92. The controller 18 can be in electrical communication with each of the battery 92 and the inverter 94.

The controller 18 can be configured to supply power from the battery 92 to the steering motor 60 based on the steering angle and the image data. The controller 18 can be configured to cause the inverter 94 to supply power to the AC electric motor 90 based on the vehicle speed and the image data.

The vehicle 10 can include a speed sensor 96 that can output data/signals that is/are indicative of the travel speed of the vehicle 10. The controller 18 can be in electrical communication with the speed sensor 96.

Electrical communication lines (not numbered) can connect the controller 18 to power source 20, the sensors 50, 52, 96, the steering motor 60, the radar 74, the lidar 76, the camera 78, the GPS antenna 80, the battery 92 and the inverter 94 in any appropriate manner. Electrical communication can be either one-way communication or two-way communication and can be networked or not networked. The electrical communication can be wired, wireless, or a combination of wired and wireless.

While certain embodiments of the invention are described above, it should be understood that the invention can be embodied and configured in many different ways without departing from the spirit and scope of the invention.

Instead of driving the rear wheels 16L, 16R and steering the front wheels 14L, 14R, exemplary embodiments of the vehicle 10 can steer the rear wheels 16L, 16R and drive the front wheels 14L, 14R, or can steer and drive all wheels or less than all wheels.

The controller 18 can be located in the body of the vehicle 10, or can be located at an end of the tether 42 with communication line embedded in the tether 42 back to the sensors and possibly another control unit in the housing of the vehicle 10.

Instead of, or in addition to, the cargo bed 82, exemplary embodiments of the vehicle 10 can include at least one seat for a passenger.

Instead of an electric motor, the power source 20 can include an internal combustion engine, or a hybrid of an internal combustion engine and an electric motor. The power source configured as an internal combustion engine or a hybrid power source can have the engine output axis oriented in the longitudinal direction L or in the traverse direction T of the vehicle. The engine can be mounted forward of the front axles, rearward of the rear axles, or intermediate the front and rear axles.

Exemplary embodiments of the image device 30 can include any two of the radar 74, the lidar 76 and the camera 78, or all three of the radar 74, the lidar 76 and the camera 78.

In exemplary embodiment that includes an internal combustion engine, the power source 20 can include a transmission. The transmission can include a speed ratio assembly that is a stepped speed ratio assembly or a continuously variable speed ratio assembly.

In alternate embodiments, the gates 86, 88 can be removable from the body 12 to load cargo onto the body 12 and then re-attached to the body 12 after the cargo has been loaded onto the cargo bed 82.

1. An autonomous work vehicle, comprising:
a plurality of wheels, each of the wheels is rotatable about a respective rotational axis, the plurality of wheels includes at least one steerable wheel that pivots about a steering axis that is different from the respective rotational axis;
power source connected to at least one of the wheels and configured to output a drive torque to the at least one of the wheels;
a steering motor connected to the steerable wheel and configured to cause the steerable wheel to pivot about the steering axis;
an imaging device configured to output image data indicative of an external environment through which the vehicle is travelling;
a tether sensor assembly including:
a housing that includes an opening and an inside surface;
a tether that is connected to the housing, the tether configured to selectively extend out of and retract into the housing through the opening and is pivotable relative to the housing about a pivot axis, the tether includes a free end that is configured to be connected to a guide;
a fixed guide connected to and extending from the inside surface of the housing, the tether contacts the fixed guide as the tether extends out of or retracts into the housing;
a direction sensor configured to output directional data indicative of the direction of travel of the guide relative to the vehicle based on an angle at which the tether extends away from the housing; and
a distance sensor configured to output range data indicative of the distance from the vehicle to the guide based on an amount of the tether that is pulled out of the housing; and
a controller in electrical communication with the power source, the steering motor, the imaging device, and the tether sensor assembly, the controller configured to:
convert the directional data into a steering angle and cause the steering motor to pivot the steering wheel based on the steering angle and the image data; and
convert the range data into a vehicle speed and cause the power source to drive the at least one of the wheels based on the vehicle speed and the image data.

2. The autonomous work vehicle according to claim 1, further comprising:
a rack gear connected to the steerable wheel; and
a pinion gear engaging the rack gear and connected to and driven by the steering motor.

3. The autonomous work vehicle according to claim 1, further comprising:
a battery electrically connected to the controller, wherein
the power source includes an electric motor electrically connected to each of the battery and the controller, the electric motor is configured to output the drive torque to the at least one of the wheels.

4. The autonomous work vehicle according to claim 1, wherein the imaging device includes at least one of a radar, a lidar, and a camera.

5. The autonomous work vehicle according to claim 1, wherein the imaging device includes a radar, a lidar, and a camera.

6. The autonomous work vehicle according to claim 1, further comprising:
a body supported by the wheels and including a cargo bed; and
at least one of a side gate and a tailgate that extends along the bed and is movably connected to the to the body.

7. An autonomous work vehicle, comprising:
a pair of front wheels, each of the front wheels is rotatable about a respective rotational axis and pivotable about a respective steering axis that is different from the rotational axis;
a pair of rear wheels, each of the rear wheels is rotatable about a common rotational axis;
a power source connected to and configured to output a drive torque to the rear wheels;
an electric steering motor connected to the front wheels and configured to cause each of the front wheels to pivot about the respective steering axis;
an imaging device configured to output image data indicative of an external environment through which the vehicle is travelling;
a tether sensor assembly including:
a housing that includes an opening and an inside surface;
a tether that is connected to the housing and selectively extends out of and retracts into the housing through the opening and is pivotable relative to the housing about a pivot axis, the tether includes a free end that is configured to be connected to a guide;
a fixed guide connected to and extending from the inside surface of the housing, the tether contacts the fixed guide as the tether extends out of or retracts into the housing;
a direction sensor configured to output directional data indicative of the direction of travel of the guide relative to the vehicle based on an angle at which the tether extends away from the housing; and
a distance sensor configured to output range data indicative of the distance from the vehicle to the guide based on an amount of the tether that is pulled out of the housing; and
a controller in electrical communication with the power source, the electric steering motor, the imaging device, and the tether sensor assembly, the controller configured to:
convert the directional data into a steering angle and cause the electric steering motor to pivot the front wheels based on the steering angle and the image data; and
convert the range data into a vehicle speed and cause the electric drive motor to drive the rear wheels based on the vehicle speed and the image data.

8. The autonomous work vehicle according to claim 7, wherein the electric steering motor is a DC motor and the power source includes an AC electric motor.

9. The autonomous work vehicle according to claim 8, further comprising:
a battery in electrical communication with the controller; and
an inverter in electrical communication with the battery, the controller and the AC electric motor.

10. The autonomous work vehicle according to claim 7, further comprising:
a pair of driveshafts, each of the driveshafts is connected to a respective one of the rear wheels; and
a differential gear assembly driven by the electric drive motor and selectively driving one or both of the driveshafts.

11. The autonomous work vehicle according to claim 7, further comprising:
a body supported by the front wheels and the rear wheels; and
a pair of steering knuckles, each of the steering knuckles supports a respective one of the front wheels to rotate about the respective rotational axis, each of the steering knuckles is connected to the body and pivots relative to the body about the respective steering axis.

12. The autonomous work vehicle according to claim 11, wherein the body includes a cargo bed and at least one gate that is pivotally connected at the cargo bed.

13. The autonomous work vehicle according to claim 11, wherein the imaging device includes at least one of a radar, a lidar, and a camera mounted on the body.

14. The autonomous work vehicle according to claim 7, further comprising:
a rack gear;
a first tie rod connected to the rack gear and a first one of the front wheels;
a second tie rod connected to the rack gear and a second one of the front wheels; and
a pinion gear engaging the rack gear and connected to and driven by the electric steering motor.

15. An autonomous work vehicle, comprising:
a vehicle body;
a plurality of wheels mounted on the vehicle body, each of the wheels is rotatable about a respective rotational axis, the plurality of wheels includes at least one steerable wheel that pivots about a respective steering axis that is different from the respective rotational axis;
an electric drive motor connected to at least one of the wheels and configured to output a drive torque to the at least one of the wheels;
an electric steering motor connected to the steerable wheel and configured to cause the at least one steerable wheel to pivot about the respective steering axis;
an imaging device mounted on the vehicle body and configured to output image data indicative of an external environment through which the vehicle is travelling;
a housing that includes an opening and an inside surface;
a tether connected to the housing, extending through the opening, selectively extendable towards and away from the vehicle body, and pivotable relative to the vehicle body, the tether includes a free end that is configured to be connected to a guide;
a fixed guide connected to and extending from the inside surface of the housing, the tether contacts the fixed guide as the tether extends out of or retracts into the housing;
a directional sensor configured to output directional data indicative of the direction of travel of the guide relative to the vehicle based on a location associated with the free end of the tether relative to the vehicle body;
a distance sensor configured to output range data indicative of a distance from the vehicle to the guide based on the location associated with the free end of the tether relative to the vehicle body; and
a controller in electrical communication with the electric drive motor, the electric steering motor, the imaging device, the direction sensor, and the range sensor, the controller configured to:
convert the directional data into a steering angle and cause the electric steering motor to pivot the steering wheel based on the steering angle and the image data; and
convert the range data into a vehicle speed and cause the electric drive motor to drive the at least one of the wheels based on the vehicle speed and the image data.

16. The autonomous work vehicle according to claim 15, wherein the tether is one of a metal wire and a plastic string.

17. The autonomous work vehicle according to claim 16, further comprising:
a spool rotatably supported in the housing and supporting a wound portion of the tether; and
a movable tether guide that is movably supported in the housing, wherein
the tether includes a connection end that is connected to the spool,
the directional sensor is configured to detect movement of the tether guide relative to the vehicle body,
the distance sensor is configured to detect rotary motion of the spool,
the fixed guide is located between the spool and the movable tether guide in an extending direction of the tether, and
the movable tether guide is located between the fixed guide and the opening of the housing in the extending direction of the tether.

18. The autonomous work vehicle according to claim 17, wherein the free end of the tether includes an anchor configured to releasably connect the tether to the guide.

19. The autonomous work vehicle according to claim 18, further comprising:
a spring biasing the spool in a direction that places the tether in tension if the anchor is secured to the guide, the spring is configured to cause the spool to retract a portion of the tether that is outside of the vehicle body, to wind the portion onto the spool if tension in the tether is below a predetermined threshold.

20. The autonomous work vehicle according to claim 15, further comprising:
a battery in electrical communication with the controller; and
an inverter in electrical communication with the battery, the controller, and the electric drive motor, wherein
the controller is configured to:
supply power from the battery to the electric steering motor based on the steering angle and the image data; and
cause the inverter to supply power to the electric drive motor based on the vehicle speed and the image data.
